(19) United States
(12) Patent Application Publication
(10) Pub. No.: US 2019/0083342 A1
(43) Pub. Date: Mar. 21, 2019

(54) DEVICE FOR MOBILISING THE SACROILIAC JOINT (SIJ) OF A PATIENT, PARTICULARLY FOR LOOSENING A BLOCKAGE OF THE SACROILIAC JOINT OF THE PATIENT

(71) Applicant: Kamran Minaian, Neuss (DE)

(72) Inventor: Kamran Minaian, Neuss (DE)

(21) Appl. No.: 16/082,438

(22) PCT Filed: Mar. 3, 2017
(86) PCT No.: PCT/EP2017/055019

§ 371 Date: Sep. 5, 2018

(30) Foreign Application Priority Data
Mar. 11, 2016 (DE) 10 2016 104 457.1

(51) Int. Cl. A61G 13/00; A61H 1/02

(52) U.S. Cl. CPC A61G 13/009; A61G 13/123; A61H 1/0222

(57) ABSTRACT

The invention relates to a device (10) for mobilising the sacroiliac joint (1) of a patient, particularly for loosening a blockage of the sacroiliac joint of the patient, comprising: a treatment table (20) with a lying surface (30) for the patient, the lying surface (30) having an opening (40) in the region of the sacroiliac joint (1) of the patient; a holding device (50) for arranging the pelvis (2) of the patient in relation to the treatment table (20); and at least one force transmission element (60) arranged in the region of the opening (40) of the lying surface (30), the force transmission element being designed to exert a force on the sacrum (3) of the sacroiliac joint (1) of the patient, by means of a movement.

### BACKGROUND OF THE INVENTION

### Field of the Invention

The invention relates to a device for mobilizing the sacroiliac joint (SIJ) of a patient, in particular for releasing a blockage of the sacroiliac joint of the patient.

The sacroiliac joint, also called SIJ, sacral iliac joint, or iliac joint, is located at the lower end of the lumbar spine in the lower part of the back of a human. The joint partners of the SIJ are the pelvis shovels (osilium) and the sacral bone (sacrum). The sacrum is adjacent to the left and right pelvis shovel, which can be also referred to as the right and left sacroiliac joint. The term sacroiliac joint, or SIJ, used in the following refers to the left and right sacroiliac joints of a human.

The sacroiliac joint establishes a connection via the sacrum between the spine and the pelvis of the human. The sacroiliac joint is a tight joint that allows very little movement, contrary to many other joints in the human body. The sacroiliac joint is stabilized by ligaments and muscles and cannot be moved arbitrarily.

When the flexibility of the sacroiliac joint is impaired, or the position of the joint surfaces deviates from the norm, it is called an SIJ blockade. Such an SIJ blockade, for example, causes a pulling pain in the area of the sacroiliac joint.

An SIJ blockage is usually treated by physiotherapy, in which the sacroiliac joint is mobilized manually and the surrounding musculature is strengthened. At the same time, heat treatments are often used to relax the surrounding muscles of the sacroiliac joint.

In the following description, the directional terms “transversal” refer to a top/bottom (head/foot) direction of a patient and “sagittal” to a left/right direction of a patient. The directional indication “frontal” refers to a front/back (abdomen/back) direction of a patient.

A sagittal plane in the sense of medicine/anatomy is a plane extending from the head to the pelvis and from the back to the abdomen. The sagittal plane divides the human body into left and right parts. In medicine/anatomy, the transversal plane is a plane perpendicular to the longitudinal axis in a standing human, i.e. a horizontal plane. The transversal plane thus divides the human body into an upper and a lower part. A frontal plane in medicine/anatomy refers to the plane of movement visible in a human's front view. The frontal plane divides the human body into a front and a back part.

### Discussion of the Prior Art

For the treatment of low back pain, JP 2013-022317 A discloses a device for training the muscles of the lower abdomen. The device comprises a treatment table with a lying surface for a patient. The lying surface has an opening in the region of the buttocks of the patient. The patient is fixed above the pelvis relative to the treatment table by means of a holding device. Disposed within the opening of the treatment table is a force transmitting member that applies a force to the buttocks of the patient to induce movement of the patient's pelvis, thereby training the lower abdominal musculature. By training the lower abdominal muscles back pain in the lower spine area should be prevented.

U.S. Pat. No. 8,439,948 B1 discloses an apparatus for treating a patient's pain in the area of the sacroiliac joint. The disclosed device comprises a treatment table having a patient support surface, the patient support surface having an opening in the region of the patient's sacroiliac joint. In the opening of the lying surface two force transmission elements are arranged, which can act on the sacroiliac joint of the patient. The device further comprises two holding devices, which are rigidly connected to the force transmission elements, so that by means of the holding devices, the patient is fixed relative to the force transmission elements. By a movement of the force transmission elements together with the holding elements, the surrounding muscles of the sacroiliac joint are trained, whereby the pain in the sacroiliac joint of the patient are to be alleviated.

The aforementioned devices exercise the surrounding muscles of the sacroiliac joint but are not suitable for a selective mobilization of the sacroiliac joint.

### SUMMARY OF THE INVENTION

It is an object of the present invention to provide a device for a selective mobilization of the sacroiliac joint of a patient, in particular for the selective movement of the sacral relative to the pelvic shovels.

According to the invention the object is achieved by a device for mobilizing the sacroiliac joint (SIJ) of a patient, in particular for releasing a blockage of the sacroiliac joint of the patient, comprising:
a treatment table with a lying surface for the patient, the lying surface having an opening in the region of the sacroiliac joint of the patient;
a holding device for arranging the pelvis of the patient relative to the treatment table; and
at least one force transmission element arranged in the region of the opening of the lying surface, the force transmission element being designed to exert a force on the sacrum of the sacroiliac joint of the patient by means of a movement.

By means of the device according to the invention the pelvis of a patient is fixed relative to the treatment table, by a correspondingly formed holding device. An opening in the area of the patient's sacroiliac joint is arranged in the lying surface for the patient of the treatment table. In the region of the opening of the lying surface, a force transmission element is arranged, which exerts a force on the sacrum of the sacroiliac joint of the patient by means of a movement. In contrast to the devices known from the prior art, according to the invention the patient's pelvis is fixed relative to the treatment table by means of the device and a force is exerted on the sacrum by means of the force transmission element. Since the patient's pelvis is fixed relative to the treatment table, the force exerted on the sacrum immediately causes mobilization of the patient's sacroiliac joint. In the devices known from the prior art, the musculature surrounding the sacroiliac joint is strengthened in order to dissolve the blockage of the sacroiliac joint.

According to a preferred variant of the invention, the at least one force transmission element is arranged movably in the region of the opening of the lying surface, in particular movable in the longitudinal direction (transverse direction) and/or lateral direction (sagittal direction) of the lying surface of the treatment table. Because the at least one force transmission element is movably arranged in the region of the lying surface, the sacrum of the patient's sacroiliac joint can be selectively mobilized, for example by virtue of the force transmission element transmitting a force at different points of the sacrum. Preferably, the at least one force transmission member can be moved in the longitudinal and lateral directions of the lying surface of the treatment table so that the at least one force transmission member can theoretically reach any point of the sacrum of the patient's sacroiliac joint and transmit a corresponding force.

According to a further variant of the invention, the angle of the at least one force transmission element in at least one direction, preferably in the transverse and sagittal direction, is adjustable relative to the lying surface of the treatment table. By adjusting the angle of the at least one force transmission element relative to the lying surface of the treatment table, the angle of the force transmitted to the sacrum of the patient's sacroiliac joint is simultaneously changed in addition to the transversal and/or sagittal orientation of the force transmission element. The articular surfaces of the sacroiliac joint between the pelvic paddles and the sacrum are inclined in the transversal plane. It has been found to be particularly advantageous if the at least one force transmission element exerts a correspondingly inclined force on the sacrum of the sacroiliac joint.

The alignment of the at least one force transmission element to the sacroiliac joint, in particular the sacrum of the sacroiliac joint, preferably takes place by means of imaging methods, such as X-ray, magnetic resonance imaging (MRI) or similar methods, by means of which the sacroiliac joint can be assessed or measured beforehand. Based on the anatomical information on the sacroiliac joint determined by means of the imaging method, the force transmission to the sacroiliac joint can be exactly adapted to the respective patient by means of the device according to the invention.

According to an advantageous variant, the at least one force transmission element is piston-shaped.

According to a further variant of the invention, the at least one force transmission element is designed to be variable in its longitudinal direction in order to exert a force on the sacrum of the patient's sacroiliac joint. For example, one end of the force transmission member is fixedly secured to a moving mechanism below the treatment table, and a change in the length of the force transmission member exerts a force on the sacrum of the patient's sacroiliac joint.

In an advantageous variant of the invention, the at least one force transmission element has a padding on the surface facing the patient. As a result, unpleasant pressure points in the region of the sacrum, where a force is transmitted to the sacrum by the force transmission element, can be avoided for the patient.

The patient facing end of the force transmission element may include additional functional units, such as a heat source, an ultrasonic source, a shock wave source and/or a laser source. Advantageously, the end facing the patient is modular or interchangeable, so that different additional functional units can be used by simply exchanging the end of the force transmission element facing the patient.

According to a further advantageous variant, the end of the force transmission element facing the patient is curved in a sagittal and/or frontal direction, the curvature facing the patient, particularly in the sagittal plane, or directed laterally outwards in the frontal plane. Such a curved end of the power transmission element ensures optimal power transmission to the sacrum of the patient.

The end of the force transmission element facing the patient has, for example, an oval cross section, the longitudinal axis of which runs approximately parallel to the longitudinal axis of the patient lying on the lying surface of the treatment table.

According to a further variant of the invention, the holding device is attached to the treatment table or integrally formed therewith. The holding device is designed, for example, as an adjustable holding frame or as an adjustable holding strap.

In an advantageous variant of the invention, the holding device at least partially has a padding on the surface facing the patient. As a result, unpleasant pressure points for the patient during the fixation of the pelvis relative to the treatment table can be avoided.

According to an advantageous variant of the invention, the lying surface of the treatment table is at least partially padded.

According to an advantageous variant of the invention, the opening of the lying surface is covered with a flexible cover, in particular a membrane. Alternatively, the end of the at least one force transmission element facing the patient has a cover. As a result, the patient does not come into direct contact with the at least one force transmission element and, after use of the device according to the invention, the flexible cover of the opening of the lying surface or the cover of the at least one force transmission element must at most be replaced before a new patient can use the device according to the invention.

According to a particularly preferred variant of the invention, the device further comprises an electronic control unit for controlling the movement of the at least one force transmission element. For example, the electronic control unit automatically executes the movement of the at least one force transmission element in accordance with a stored exercise program. The patient lies down on the lying surface of the treatment table, wherein the patient's sacroiliac joint is arranged in the region of the opening in the lying surface of the treatment table. The pelvis of the patient is fixed relative to the treatment table by means of the holding device. Subsequently, the exercise program stored in the electronic control unit is activated, and the electronic control unit moves the at least one force transmission member so as to exert a force on the sacrum of the patient's sacroiliac joint. The movement program is preferably designed such that the at least one force transmission element exerts different forces on the sacrum of the patient's sacroiliac joint, for example by moving the at least one force transmission element in the transverse direction and/or sagittal direction, in particular by adjusting the angle of the at least one force transmission element to the lying surface of the treatment table.

According to a particularly advantageous variant of the invention, the device further comprises an emergency stop switch, wherein the emergency stop switch is preferably arranged such that the patient located on the lying surface of the treatment table can actuate the emergency stop button, especially if the patient's pelvis is fixed relative to the treatment table. Thus, the patient may at any time discontinue treatment by the sacroiliac joint mobilization device of the present invention, especially if the treatment causes pain to the patient. According to a further variant of the invention, the device comprises a monitoring device for monitoring the movement of the at least one force transmission element. In a particularly preferred variant, the monitoring device comprises an emergency shutdown, which shuts off the device when the at least one force transmission element leaves a predetermined range of motion. The monitoring device thus ensures that even in the event of a malfunction of the at least one force transmission element no force is exerted on the patient's sacroiliac joint, which exceeds a predetermined range of motion.

According to a variant of the invention, the at least one force transmission element is designed such that it is automatically moved to an initial position in the event of an emergency shutdown, in which the at least one force transmission element is not in contact with the patient lying on the lying surface of the device. In the case of a pneumatic force transmission element, for example, the pneumatic pressure could be released, whereby the at least one force transmission element returns to its original position. In the case of an electric power force element, an electrical energy storage device may be provided which can drive the electric force transmission element after an emergency shutdown so that it is moved back to an initial position.

According to a particularly preferred variant of the invention, the device comprises two force transmission elements, wherein the two force transmission elements can independently or jointly exert a force on the sacrum of the patient's sacroiliac joint. By means of two force transmission elements, for example, transverse forces could be exerted on the sacrum of the patient's sacroiliac joint, which could not be applied by a single force transmission element. In combination with the aforementioned possibilities of movement of the force transmission elements, for example in the longitudinal and/or lateral direction of the lying surface of the treatment table and the angle relative to the treatment table, the patient's sacroiliac joint can be mobilized by means of the two force transmission elements in an almost unrestricted manner. In a further variant, the device according to the invention comprises guide means for guiding the force transmission elements and/or for guiding the movement of the force transmission elements in the longitudinal and/or lateral direction.

According to a particularly advantageous variant, the lying surface of the treatment table comprises an additional leg rest, which is designed in particular such that the knees of the patient lying on the device according to the invention are angled. It has been found that such a leg position is particularly advantageous in the mobilization of the sacroiliac joint by means of the device according to the invention.

According to a particularly preferred variant of the invention, the device is designed such that the at least one force transmission element moves on a curved path, in particular a circular path, relative to the lying surface of the treatment table, in particular curved in the lateral direction of the lying surface of the treatment table. Since the articular surfaces of the sacroiliac joint between the pelvis and the sacrum are also curved, the movement of the at least one force transmission element on a curved path, in particular a circular path, relative to the lying surface of the treatment table creates a force substantially along the articular surfaces of the sacroiliac joint. As a result, the patient's sacroiliac joint can be selectively mobilized. The movement of the at least one force transmission element on a curved path, in particular a circular path, relative to the lying surface of the treatment table is achieved for example by appropriately designed guide means and/or by specially designed means for moving the at least one force transmission element.

According to a further preferred variant of the invention, the at least one force transmission element is curved, in particular curved in the lateral direction of the lying surface of the treatment table. Thus, the at least one force-transmission element extends substantially along the curved articular surfaces of the sacroiliac joint between the pelvis and the sacrum of the patient.

### BRIEF DESCRIPTION OF THE DRAWINGS

In the following the invention will be explained in more detail with reference to an embodiment shown in the figures. It shows:

FIG. 1 a schematic view of a sacroiliac joint of a human;

FIG. 2 a view of a device according to the invention in the region of the sacroiliac joint of a patient in the transversal plane;

FIG. 3 a view of the device according to the invention of FIG. 2 in the sagittal plane, and

FIG. 4 view of a further device according to the invention in the region of the sacroiliac joint of a patient in the transverse direction.

### DESCRIPTION OF A PRESENTLY PREFERRED EMBODIMENT

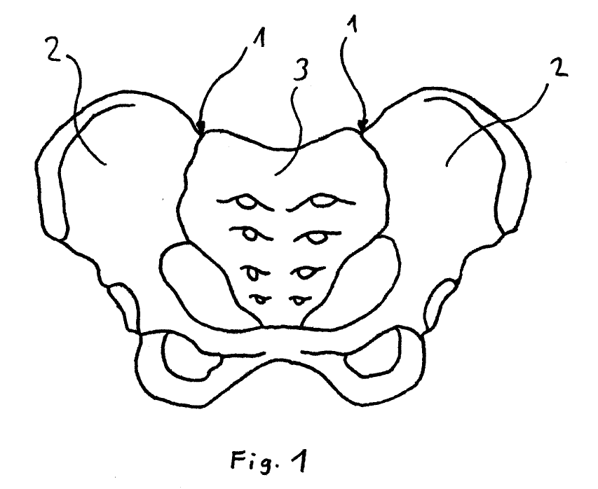

FIG. 1 shows a schematic view of a human sacroiliac joint 1, also called SIJ, sacro-iliac joint or sacral iliac joint. The sacroiliac joint 1 is located in the lower part of the back at the end of the lumbar spine. The sacroiliac joint 1 is formed between the pelvic shovels 2 (Latin: osilium) and the sacrum (Latin: sakrum). The sacroiliac joint 1 thus establishes the connection between the spine and pelvic shovels 2 via the sacrum 3. The sacroiliac joint 1 cannot be moved arbitrarily and is stabilized by ligaments and muscles. The sacroiliac joint 1, contrary to many other joints in the human body, only allows very little movement and is therefore referred to as a tight joint. The possible movements of the sacroiliac joint are called nutation and counternutation. Nutation causes, for example, an enlargement of the pelvic ring, which is of great importance in particular at a birth.

A blockage of the sacroiliac joint 1 arises, for example, when the already tight joint is limited in its mobility or when the position of the articular surfaces deviates from the norm. A blockage of the sacroiliac joint 1 is often noticeable by a pulling pain in the region of the sacroiliac joint 1. The cause of a blockage of the sacroiliac joint 1 is often lifting too heavy loads, the wrong lifting or a kick to the void, such as missing a step. Furthermore, spinal diseases, a pelvic obliquity, a leg length difference or inappropriate biomechanical stress may favour the development of blockage of the sacroiliac joint 1.

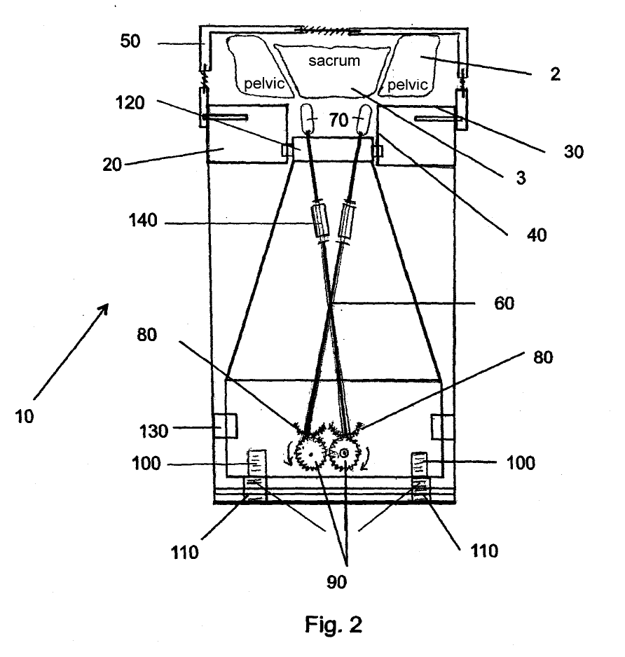

FIG. 2 shows a view of a device 10 according to the invention in the area of the sacroiliac joint 1 of a patient in the transversal plane, that is to say a sectional view through the longitudinal axis of the patient. The device 10 for mobilizing the patient's sacroiliac joint 1, in particular for releasing a blockage of the patient's sacroiliac joint 1, comprises a treatment table 20 with a lying surface 30 for the patient. The lying surface 30 has an opening 40 in the region of the sacroiliac joint 1 of the patient. The device 10 further comprises a holding device 50 for fixing the pelvis 2 of the patient relative to the treatment table 20. In order to mobilize the patient's sacroiliac joint 1, the device 10 further comprises at least one force transmission element 60 arranged in the region of the opening 40 of the lying surface 30, wherein the force transmission element 60 is designed to exert a force on the sacrum 3 of the patient's sacroiliac joint 1 by a movement.

In the embodiment shown in FIG. 2, the device 10 comprises two force transmission elements 60, wherein the two force transmission elements 60 can independently or jointly exert a force on the sacrum 3 of the patient's sacroiliac joint 1. The ends 70 of the two force-transmission elements 60, which are arranged immediately adjacent to the patient, expediently have a padding on the surface facing the patient. Further, in particular the patient-facing ends 70 of the force transmission members 60, may include other functional units (not shown), such as a heat source, an ultrasound source, a shockwave source, and/or a laser source. Advantageously, the patient facing ends 70 are modular or interchangeable, so that different additional functional units can be used by simply replacing the patient facing end 70 of the force transmission element 60.

The two force transmission elements 60 are movably arranged in the region of the opening 40 of the lying surface 30, in particular movable in the longitudinal direction (sagittal direction) and/or lateral direction (transverse direction) of the lying surface 30 of the treatment table 20. The movement of the force transmission elements 60 in the sagittal direction (left/right) is realized according to FIG. 2, for example, by means of saggital curved tooth rails 80 arranged at the lower ends of the force transmission elements 60 and drivable, sagittal toothed wheels 90 operatively connected to the sagittal curved tooth rails 80. In the region of the opening 40 in the lying surface 30 of the treatment table 20 saggital guide means 120 are arranged. By driving one or both of the sagittal gears 90, the respective lower end of the force transmission element 60 is pivoted over the corresponding sagittal curved toothed rail 80. Since the respective force transmission element 60 is rotatably mounted in the region of the sagittal guide means 120, the pivoting of the force transmission elements 60 causes a corresponding movement of the patient facing ends 70 of the force transmission elements 60 in the sagittal (left/right) direction.

Consequently, the angles of the force transmission elements 60 in the sagittal direction relative to the lying surface 30 of the treatment table 20 are changed or adjusted.

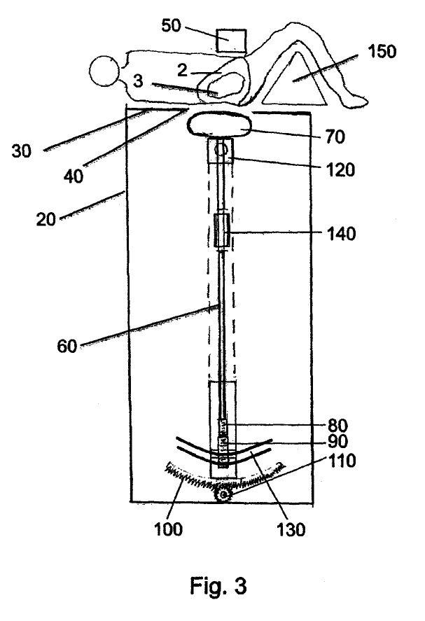

The movement of the force transmission elements 60 in the transverse direction is shown in particular in FIG. 3. For this purpose, the device 10 according to the invention has, for example, a transversely curved toothed rail 100 in the lower region. The transversely curved toothed rail 100 is connected to the means for adjusting the sagittal direction 80, 90 and the lower ends of the force transmission elements 60. The transverse curved toothed rail 100 can be pivoted via the driven transverse toothed wheel 110, which is in operative connection with the transversely curved toothed rail 100, and thus also the means for adjusting the sagittal direction and the force transmission elements 60. To guide the transverse movement of the force transmission elements 60 further guide means 130 are provided, which consist for example as a curved groove and a sliding component contained therein, wherein the sliding component is firmly connected to the means for sagittal movement or the force transmission elements 60.

According to a further advantageous variant, the ends 70 of the force-transmission elements 60 facing the patient are curved in a sagittal and/or frontal direction, the curvature facing the patient, in particular in the sagittal plane, or directed laterally outwards in the frontal plane. Such curved ends 70 of the force transmission elements 60 ensure optimum force transmission to the sacrum 3 of the patient.

The force transmission elements 60 of FIG. 2 are designed to be variable in their longitudinal direction in order to exert a force on the sacrum 3 of the patient's sacroiliac joint 1. For this purpose, the force transmission elements 60 can be moved for example by a corresponding device towards the sacrum 3 of the patient to be treated or the force transmission elements 60 comprise means for changing the length of the force transmission elements 60. The force transmission elements 60 may be formed, for example, as variable-length piston elements.

Advantageously, the force transmission elements 60 have a padding 70 on the surface facing the patient.

As can be seen in FIG. 2, the holding device 50 is mounted to the treatment table 20. The holding device 50 from FIG. 2 is designed as an adjustable holding frame. Alternatively, the holder device 50 may be formed as an adjustable belt.

Advantageously, the holding device 50 at least partially comprises a padding on the surface facing the patient. Likewise, the lying surface 30 of the treatment table 20 is preferably at least partially padded.

FIG. 3 is a view of the device according to the invention of FIG. 2 in the sagittal plane. The device 10 for mobilizing the sacroiliac joint 1 of a patient, in particular for releasing a blockage of the patient's sacroiliac joint 1, from FIG. 3 comprises the treatment table 20 with the patient's lying surface 30, the holding device 50 for fixing the patient's pelvis 2 relative to the treatment table 20 and two force transmission elements 60 arranged in the region of the opening 40 of the lying surface 30.

The opening 40 in the lying surface 30 of the treatment table 20 is located in the region of the patient's sacroiliac joint 1 so that the force transmission elements 60 can exert a force on the sacrum 3 of the patient's sacroiliac joint 1 when the force transmission elements 60 are moved relative to the patient's pelvis 2.

The movement of the force transmission elements 60 in the sagittal direction can be seen in particular from FIG. 2. For movement of the force transmission elements 60 in the transverse direction, the device has, as already explained above and shown in particular in FIG. 3, a transversely curved toothed rail 100 in the lower region. The transversely curved toothed rail 100 is connected to the means for adjusting the sagittal direction 80, 90 and the lower ends of the force transmission elements 60. The transverse curved toothed rail 100 can be pivoted via the driven transverse toothed wheel 110, which is in operative connection with the transversely curved toothed rail 100, and thus also the means for adjusting the sagittal direction and the force transmission elements 60. To guide the transverse movement of the force transmission means 60 further guide means 130 are provided, which consist for example of a curved groove and a sliding component contained therein, wherein the sliding component is firmly connected to the means for sagittal movement or the force transmission elements 60.

The device 10 of FIGS. 2 and 3 further comprises an electronic control unit (not shown) for controlling the movement of the two force transmission elements 60. The electronic control unit automatically executes movement of the power transmission members 60 in accordance with a stored motion program.

The device 10 according to the invention may further comprise a monitoring device for monitoring the movement of the two force transmission elements 60. For example, this monitoring device is integrated in the electronic control unit. The monitoring device includes, for example, an emergency shutdown, which shuts off the device 10 when at least one force transmission element 60 leaves a predetermined range of motion. Alternatively or additionally, the device 10 according to the invention may comprise an emergency stop switch, which is preferably operable by the patient, even if the patient is fixed by means of the holding device 50 relative to the lying surface 30 of the treatment table 20.

In the event of an emergency shutdown, the at least one force transmission element 60 is advantageously moved automatically into an initial position in which the at least one force transmission element 60 is not in contact with the patient lying on the lying surface 30 of the device 10.

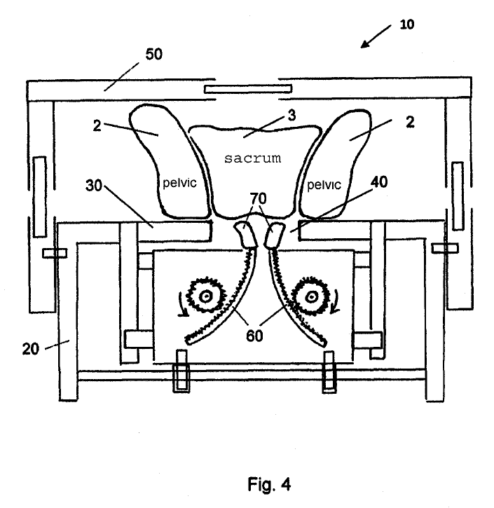

FIG. 4 shows a view of a device 10 according to the invention in the region of the sacroiliac joint 1 of a patient in the transversal plane, that is to say a sectional view through the longitudinal axis of the patient. The device 10 for mobilizing the patient's sacroiliac joint 1, in particular for releasing a blockage of the patient's sacroiliac joint 1, comprises a treatment table 20 with a lying surface 30 for the patient. The lying surface 30 has an opening 40 in the region of the sacroiliac joint 1 of the patient. The device 10 further comprises a holding device 50 for fixing the pelvis of the patient relative to the treatment table 20. In order to mobilize the patient's sacroiliac joint 1, the device 10 further comprises at least one force transmission element 60 arranged in the region of the opening 40 of the lying surface 30, wherein the force transmission element 60 is designed to exert a force on the sacrum 3 of the patient's sacroiliac joint 1 by a movement.

In the embodiment shown in FIG. 4, the device 10 comprises two force transmission elements 60, wherein the two force transmission elements 60 can independently or jointly exert a force on the sacrum 3 of the patient's sacroiliac joint 1. The ends 70 of the two force-transmission elements 60, which are arranged immediately adjacent to the patient, expediently have a padding on the surface facing the patient. Further, in particular, the patient-facing ends 70 of the force transmission members 60 may include other functional units (not shown), such as a heat source, an ultrasound source, a shockwave source, and/or a laser source. Advantageously, the ends 70 facing the patient are modular or interchangeable, so that different additional functional units can be used by simply exchanging the ends 70 of the force transmission element 60 facing the patient.

The embodiment according to FIG. 4 differs from the embodiment according to FIG. 2 in particular in that the device 10 is designed such that the two force transmission elements 60 each move on a curved path, in particular a circular path relative to the lying surface 30 of the treatment table 20, in particular curved in the lateral direction of the lying surface 30 of the treatment table 20. For this purpose, the device 10 may have, for example, correspondingly designed guide elements and/or as indicated in FIG. 4 the means for moving the force transmission elements 60 are formed such that the force transmission elements 60 move on a curved path, in particular a circular path, relative to the lying surface 30 of the treatment table 20. Further, FIG. 4 shows that the force transmission elements 60 are curved, in particular curved in the lateral direction of the lying surface 30 of the treatment table 20. The curvature of the force transmission elements 60 is substantially matched to the curvature of the articular surfaces of the patient's sacroiliac joint 1 between the pelvis and the sacrum.

Furthermore, reference is made to the previous statements, which are also valid for the device according to FIG. 4.

### LIST OF REFERENCE NUMBERS

1 sacroiliac joint
2 pelvic shovel/pelvis
3 sacrum
10 device
20 treatment table
30 lying surface
40 opening lying surface
50 holding device
60 force transmission element
70 patient facing end of the force transmission element
80 sagittal curved toothed rail
90 sagittal gear
100 transversal curved toothed rail
110 transverse gear
120 sagittal guide means
130 transversal guide means
140 means for changing the length of the force transmission means
150 leg rest

We claim:

1. Device for mobilizing the sacroiliac joint of a patient, in particular for releasing a blockage of the patient's sacroiliac joint, comprising:
a treatment table with a lying surface for the patient, the lying surface having an opening in the region of the sacroiliac joint of the patient;
a holding device for arranging the pelvis of the patient relative to the treatment table; and
at least one force transmission element arranged in the region of the opening of the lying surface, the force transmission element being designed to exert a force on the sacrum of the sacroiliac joint of the patient by means of a movement.

2. Device according to claim 1, wherein the at least one force transmission element is arranged movably in the region of the opening of the lying surface, in particular movable in the longitudinal direction and/or lateral direction of the lying surface of the treatment table.

3. Device according to claim 1, wherein the angle of the at least one force transmission element relative to the lying surface of the treatment table is adjustable in at least one direction.

4. Device according to claim 1, wherein the patient facing end of the force transmission element comprises an additional functional unit, such as a heat source, an ultrasonic source, a shock wave source and/or a laser source.

5. Device according to claim 1, wherein the at least one force transmission element is designed to be variable in its longitudinal direction in order to exert a force on the sacrum of the patient's sacroiliac joint.

6. Device according to claim 1, wherein the at least one force transmission element has a padding on the surface facing the patient.

7. Device according to claim 1, wherein the holding device is attached to the treatment table.

8. Device according to claim 1, wherein the holding device is designed as an adjustable holding frame or as an adjustable holding strap.

9. Device according to claim 1, wherein the holding device at least partially has a padding on the surface facing the patient.

10. Device according to claim 1, wherein the lying surface is at least partially padded.

11. Device according to claim 1, wherein the opening of the lying surface is covered with a flexible cover, in particular a membrane, and/or the end of the at least one force transmission element facing the patient has a cover.

12. Device according to claim 1, further comprises an electronic control unit for controlling the movement of the at least one force transmission element.

13. Device according to claim 1, wherein the electronic control unit automatically executes the movement of the at least one force transmission element in accordance with a stored exercise program.

14. Device according to claim 1, further comprising an emergency stop switch.

15. Device according to claim 1, further comprising a monitoring device for monitoring the movement of the at least one force transmission element.

16. Device according to claim 15, wherein the monitoring device comprises an emergency shutdown, which shuts off the device when the at least one force transmission element leaves a predetermined range of motion.

17. Device according to claim 14 or claim 16, wherein the at least one force transmission element is automatically moved to an initial position in the event of an emergency shutdown, in which the at least one force transmission element is not in contact with the patient lying on the lying surface of the device.

18. Device according to claim 1, wherein the device comprises two force transmission elements, wherein the two force transmission elements can independently or jointly exert a force on the sacrum of the patient's sacroiliac joint.

19. Device according to claim 1, further comprising guide means for guiding the force transmission elements and/or for guiding the movement of the force transmission elements in the longitudinal and/or lateral direction.

20. Device according to claim 1, wherein the device is designed such that the at least one force transmission element moves on a curved path, in particular a circular path, relative to the lying surface of the treatment table, in particular curved in the lateral direction of the lying surface of the treatment table.

21. Device according to claim 1, wherein the at least one force transmission element is curved, in particular curved in the lateral direction of the lying surface of the treatment table.
